(19) United States
(12) Patent Application Publication
(10) Pub. No.: US 2025/0345983 A1
(43) Pub. Date: Nov. 13, 2025

(54) AIR SUPPLY SYSTEM FOR A FILM STRETCHING UNIT

(71) Applicant: BRÜCKNER MASCHINENBAU GmbH, Siegsdorf (DE)

(72) Inventors: Tobias HÄUSL, Traunstein (DE); Elena STENGEL, Siegsdorf (DE)

(21) Appl. No.: 19/202,846

(22) Filed: May 8, 2025

(30) Foreign Application Priority Data
May 10, 2024 (DE) 10 2024 113 147.0

(51) Int. Cl. B29C 55/02; B29C 35/02; B29C 35/16

(52) U.S. Cl. CPC B29C 55/02; B29C 35/02; B29C 35/16

(57) ABSTRACT

An air supply system for a stretching unit is disclosed including at least one air supply unit, at least one fresh-air supply unit and at least one exhaust-air return unit. The exhaust-air return unit and the fresh-air supply unit are assigned to a mutual first treatment zone, wherein the fresh-air supply unit is configured to supply fresh air as supply air to the first treatment zone. The exhaust-air return unit is configured to extract exhaust air from the first treatment zone and to supply at least a proportion of the exhaust air to at least one air supply unit. The air supply unit is assigned to a second treatment zone which is upstream of the first treatment zone. The air supply unit is configured to provide the proportion of the exhaust air returned by the exhaust-air return unit to the second treatment zone as supply air.

### CROSS REFERENCE TO RELATED APPLICATION

This application claims priority to German Patent Application Number DE 10 2024 113 147.0, filed May 10, 2024, the entire contents of which is hereby incorporated by reference.

### BACKGROUND

The invention relates to an air supply system for a film stretching unit as well as a film stretching unit comprising an air supply system.

Stretching units are used particularly in the production of plastics films. What are termed simultaneous stretching units are known, in which a plastic film can be stretched in the transverse direction and the machine direction at the same time. Similarly, what are termed sequential stretching units are known, in which the plastic film is stretched in two successive stages, for example first in the machine direction and then in the transverse direction (or vice versa). Finally, stretching units that stretch solely in the machine direction as well as solely in the transverse direction are known.

In typical stretching units, the material web to be stretched (for example a plastic film) is gripped on opposing edges by means of what are termed grippers. The grippers are arranged moveably on circulating guide rails, wherein the material web is guided between two guide rails.

The grippers, and thus the gripped material web, are moved successively from an entry zone (in which the edge of the material web to be stretched is gripped) via an optional preheating zone (in which the material web is temperature-controlled) and a stretching zone (in which the grippers opposite to each other are moved away from each other in a divergent manner relative to the transport direction on guide rail sections with a transverse component) to an exit zone. The grippers can then be detached from the material web and moved back to the entry zone.

The stretching zone can be downstream of at least one what is termed a treatment zone. Typically, the stretching zone adjoins at least one what is termed an annealing zone, in which the material web already stretched can undergo a heat treatment. The heat treatment is used in particular to reduce tensions in the material web that form as a result of the stretching. One or more cooling zones can adjoin after said at least one annealing zone. Further treatment zones are also possible.

The plastic film must be temperature-controlled (heated or cooled) in a targeted manner before, during and/or after the actual stretching process. To this end, the individual zones (i.e. stretching zone and potential treatment zones) are temperature-controllable.

In addition, the zones are typically coupled to an air supply system that enables the supply of supply air to the interior of the respective zone and the extraction of polluted or contaminated air (exhaust air). This is necessary as contaminants, such as monomers, oligomers, auxiliaries, additives (such as plasticiser, etc.) and/or suchlike escape from the plastic film that has not completely cooled down and accumulate in the corresponding zone, or settle, and thus lead to contamination of the unit components and/or to an impairment of the film quality.

The ventilation of the zones is however very energy intensive as the supply air, in particular when extracted from the environment, must be preheated as a rule. A film stretching unit comprising a ventilation system characterised by low energy requirements is known, for example, from EP 3 650 199 B1. However, this ventilation system is very complex and the control effort of the individual air flows is very high.

### SUMMARY

The disclosure provides an air supply system for a stretching unit as well as a stretching unit comprising an air supply system, which overcomes at least in part the aforementioned disadvantages.

The disclosure encompasses a means of an air supply system as well as a stretching unit according to the independent claims. Further aspects of the invention are specified in the dependent claims as well as in the following description.

In particular, an air supply system for a stretching unit, in particular a film stretching unit. The air supply system comprises at least one air supply unit, at least one fresh-air supply unit and at least one exhaust-air return unit.

The exhaust-air return unit and the fresh-air supply unit are assigned to a mutual first treatment zone.

The fresh-air supply unit is configured to supply fresh air as supply air to this first treatment zone. The term “fresh air” denotes here an air flow that is supplied to a treatment zone as supply air for the first time. In the simplest case, the fresh air is extracted from the environment. Similarly, it is possible to provide process gases as fresh air, and/or to mix these with the ambient air.

The exhaust-air return unit is configured to extract exhaust air from this first treatment zone. Thus by means of the exhaust-air return unit and the fresh-air supply unit, fresh air can be supplied to the first treatment zone and, simultaneously, exhaust air can be extracted.

Furthermore, the exhaust-air return unit is configured to supply at least a proportion of the exhaust air to an air supply unit. A further proportion of the exhaust air can be supplied to a further air supply unit and/or be extracted (to the environment). Before the exhaust air can be dissipated into the environment, this can be filtered so that it is substantially free of contaminants.

The air supply unit is assigned to a second treatment zone. This second treatment zone is upstream of the first treatment zone.

It can be directly adjacent to the first treatment zone, or further zones, such as a neutral zone or a further treatment zone, can be arranged between the first and the second treatment zone. The air supply unit is configured to provide the proportion of the exhaust air returned to it by the exhaust-air return unit to the second treatment zone as supply air.

In the case of a stretching unit, the supply air can be provided above and/or below a material web (e.g. a plastic film). The provision of the supply air can occur via nozzles and/or nozzle boxes. A nozzle box distributes the air flow of the supply air over the width of the material web substantially so that supply air flows over the material web as uniformly as possible.

If a plurality of air supply units (at least two) are provided, these can be supplied with a proportion of the exhaust air from this first treatment zone by the exhaust-air return unit. In addition, the air supply units are each assigned in this case to a treatment zone upstream of the first treatment zone in order to supply this with supply air.

The treatment zones can comprise at least one cooling zone and/or at least one annealing zone. In particular, the treatment zone, which is termed the first treatment zone here, can be a cooling zone that in one aspect of the invention is not succeeded by any further treatment zones. The treatment zone that is termed here the first treatment zone can be, for example, the last treatment zone of a stretching unit. The second treatment zone can also be a cooling zone.

The terms “first” and “second” treatment zones do not indicate an order in which the treatment zones are passed through (e.g. by a material web). They are only used to be able to differentiate between the treatment zones. In fact, the second treatment zone is passed through before the first treatment zone. This second treatment zone is thus upstream of the first treatment zone.

As the first treatment zone is supplied with fresh air and the exhaust air is then extracted, the fresh air supplied in this first treatment zone only comes into contact with the first treatment zone and the material contained therein (for example, a material web, such as a plastic film) once. Thus, the air is not circulated in the first treatment zone. As a result, the exhaust air removed from the first treatment zone is relatively clean (thus contains no or only very little contaminants) and thus can be reused well in other, upstream treatment zones, stretching zones and/or preheating zones, without negatively influencing the quality of the material to be treated (for example, a material web such as a plastic film). In addition, the fresh air in the first treatment zone is already preheated so that energy can be saved when temperature-controlling the supply air for the corresponding upstream zones.

In one aspect, the air supply system is configured furthermore to extract exhaust air from a second treatment zone. The exhaust air removed from the second treatment zone can be extracted at least in part. Before the exhaust air can be dissipated into the environment, this can be filtered so that it is substantially free of contaminants.

The air supply unit can be configured furthermore to mix at least a proportion (0% to 100%) of the exhaust air removed from the second treatment zone with at least a proportion of the exhaust air supplied to the air supply unit by the exhaust-air return unit in order to generate a mixed air flow. The ratio of exhaust air from the first treatment zone to exhaust air from the second treatment zone can be substantially 5:1, or substantially 4:1, or substantially 3:1, or substantially 2:1, or substantially 1:1, or substantially 1:2, or substantially 1:3, or substantially 1:4, or substantially 1:5.

In one aspect, the mixed air flow can comprise, for example, ⅓ exhaust air from the first treatment zone and ⅔ exhaust air from the second treatment zone.

In particular, the mixed air flow can be mixed in such a way that the proportion of contaminants is below a desired pre-defined limit. Furthermore, the mixed air flow can be mixed in such a way that it has the desired temperature or is in a desired temperature range. To this end, corresponding sensors can be provided. Via the mixing of the air flow, the service life of filters of the air supply system, in particular the air supply unit, can be increased in particular and/or the level of pollutants in the individual treatment zones can be reduced.

Finally, the air supply unit can be configured to provide the mixed air flow to the second treatment zone as supply air. The addition of exhaust air from the second treatment zone enables the supply air to be heated so that further energy can be saved.

Furthermore, the air supply system can be configured to solely supply fresh air to the first treatment zone as supply air. Thus, the level of contaminant can be kept very low in the exhaust air of the first treatment zone.

The air flow of the supply air to the first, second and/or any further zone can be controlled, for example, in such a way that the contaminant concentration in the exhaust air is below a predefined limit.

In addition, the dwell time of the air in the corresponding zone can be determined via the air flow of the supply air and/or the air flow of the exhaust air. The shorter the dwell time, the lower the contaminant concentration in the exhaust air. In addition, a desired pressure (overpressure, underpressure, atmospheric pressure) can be set in the corresponding zone via the air flow of the supply air and/or the air flow of the exhaust air. Via the air flow of the supply air and/or the air flow of the exhaust air, the service life of filters of the air supply system, in particular the air supply unit, can be increased in particular and/or the level of pollutants in the individual treatment zones can be reduced.

Furthermore, the air supply unit can be configured to supply solely the proportion of the exhaust air supplied to it by the exhaust-air return unit, or a mixed air flow comprising no fresh air, to the second treatment zone as supply air. The supply air that is provided by the air supply unit to the treatment zone assigned to it is thus free of fresh air. This enables energy-efficient operation as no (cold) fresh air needs to be heated. At the same time, the control effort is low compared to previously known systems.

Furthermore, the exhaust-air return unit can be configured to extract the entire exhaust air from the first treatment zone. Therefore, there are no further exhaust air outlets and the entire heated fresh air can be provided as exhaust air via the exhaust-air return unit to other zones as supply air.

In particular, the air supply system comprises at least one controllable fan, wherein said at least one controllable fan can be configured
to control a supply-air air flow of the first treatment zone, or
to control a supply-air air flow of the second treatment zone (or a further treatment zone or stretching zone), or
to control an exhaust-air air flow of the first treatment zone, or
to control an exhaust-air air flow of the second treatment zone (or a further treatment zone or stretching zone), or
to control an air flow that is supplied by the exhaust-air return unit to said at least one air supply unit.

If multiple, different air flows are to be controlled, for example to set a desired pressure or to keep a contaminant concentration low in the treatment zone, multiple fans can be provided accordingly. The fans can be part of the air supply unit, the fresh-air supply unit and/or the exhaust-air return unit. In addition, at least one fan can be arranged in an air duct (supply air or exhaust air) of the air supply system or at another location in the air supply system.

Furthermore, the air supply system can comprise at least one heating element (e.g. an electrical heating element, a fluid-conducting heating element, a heat exchanger and/or suchlike). Said at least one heating element can be configured, for example,
to temperature control a supply-air air flow of the first treatment zone, or
to temperature control a supply-air air flow of the second treatment zone (or a further treatment or stretching zone).

Thus, the temperature of the supply air can be set or controlled. This increases production quality.

Moreover, the air supply unit can comprise a condensate trap arrangement comprising at least one condensation element.

The condensate trap arrangement is used to separate (or condense out) contaminants which are entrained in the exhaust air.

To this end, the condensate trap arrangement is configured to have a proportion of the exhaust air flow through it, said proportion of the exhaust air being supplied to the air supply unit by the exhaust-air return unit. This proportion of exhaust air has a first temperature T1. In addition, this proportion of exhaust air is used to temperature control the condensation element.

Furthermore, the condensate trap arrangement is configured to have a proportion (0% bis 100%) of the exhaust air extracted from the second treatment zone flow through it, said proportion of the exhaust air having a second temperature T2. The second temperature T2 is greater than the first temperature T1.

Due to the temperature difference, the condensation element can be temperature controlled so that contaminants, which are entrained in the exhaust air extracted from the second treatment zone, precipitate (condense) at least in part on said at least one condensation element.

In the production of plastic films, contaminants comprise, for example, monomers, oligomers and/or other volatile matter that escape from the (still hot) plastic. These contaminants settle as what is termed “white powder” in the stretching unit and/or the air supply system and can damage these. For example, openings can clog, or moveable components (such as air control dampers) can become stiff or even blocked. In addition, their removal is laborious because as a rule the stretching unit must be stopped and production must be interrupted to do this. The condensate trap arrangement now enables the removal of contaminants from the air flow in a targeted manner before they settle. Thus, the service life of the unit can be increased and/or cleaning intervals can be extended. In addition, the service life of potential filters can be increased considerably by the condensate trap arrangement.

Furthermore, the condensate trap arrangement can be configured to mix the proportion of exhaust air flowing through it in order to generate a mixed air flow. It has been shown that very homogeneous mixed air flows are attainable by this means. This results in a further increase in the production quality, in particular in (film) stretching units.

The air supply unit can comprise furthermore a course filter arrangement. The course filter arrangement can filter contaminants passing through the condensate trap arrangement from the air flow. The course filter arrangement can therefore be downstream of the condensate trap arrangement.

The course filter arrangement can comprise one or more course filters, for example, which comprise a metal knit, a stretch plate, an expanded-metal grid, a wire mesh, a perforated plate, a honeycomb plate, a non-woven filter and/or suchlike. The course filter can be reusable (and accordingly cleanable) or be designed for single use.

A heating element can also be arranged between the condensate trap arrangement and the course filter arrangement. It is also possible to arrange a heating element after the course filter arrangement.

Furthermore, the air supply unit can comprise a filter arrangement which comprises at least one filter that is typically finer than the course filter. Thus, further contaminants can be removed from the air flow before this is supplied as supply air to the treatment zone. The filter arrangement is, for example, downstream of the course filter arrangement.

Moreover, the object is solved by means of a stretching unit, in particular a film stretching unit, which is configured for stretching a material web (e.g. plastic film) in the machine direction and/or transverse direction. The stretching unit comprises a stretching zone and at least two treatment zones. These can be, for example, cooling zones and/or annealing zones as described above. Further treatment zones are also possible.

In particular, the treatment zone, which is termed the first treatment zone here, can be a cooling zone that in one aspect of the disclosure is not succeeded by any further treatment zones. The second treatment zone can also be a cooling zone.

Moreover, the stretching unit comprises an air supply system, as described above.

In a further aspect of the disclosure, a preheating zone, a stretching zone and/or at least one annealing zone of the stretching unit can be supplied solely with fresh air as supply air. The fresh air can be brought to the desired temperature via heating elements (for example, heat exchangers). The exhaust air of the preheating zone, the stretching zone and/or said at least one annealing zone can be dissipated into the environment and optionally filtered. This reduces the control effort of individual air flows as well as the contaminant concentration in the stretching unit.

### BRIEF DESCRIPTION OF THE DRAWINGS

Additional features and advantages of the disclosure are found in the following description as well as the attached drawings to which reference is made. In the drawings:

FIG. 1 shows a schematic view of a stretching unit comprising an air supply system;

FIG. 2 shows a schematic view of the air supply system;

FIG. 3 shows a schematic view of an air supply unit;

FIG. 4 shows a schematic view of a condensate trap arrangement; and,

FIG. 5 shows a schematic view of a course filter arrangement.

### DETAILED DESCRIPTION

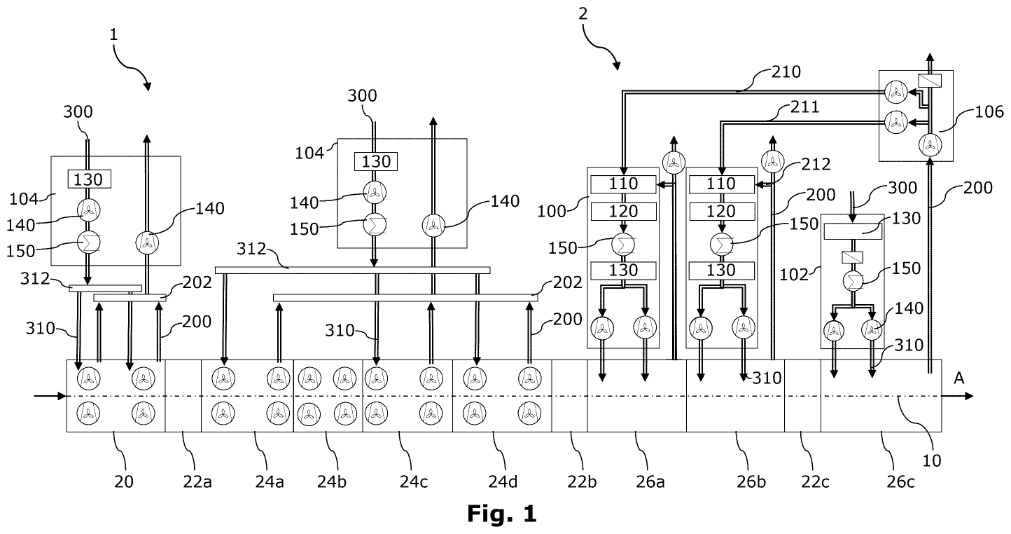

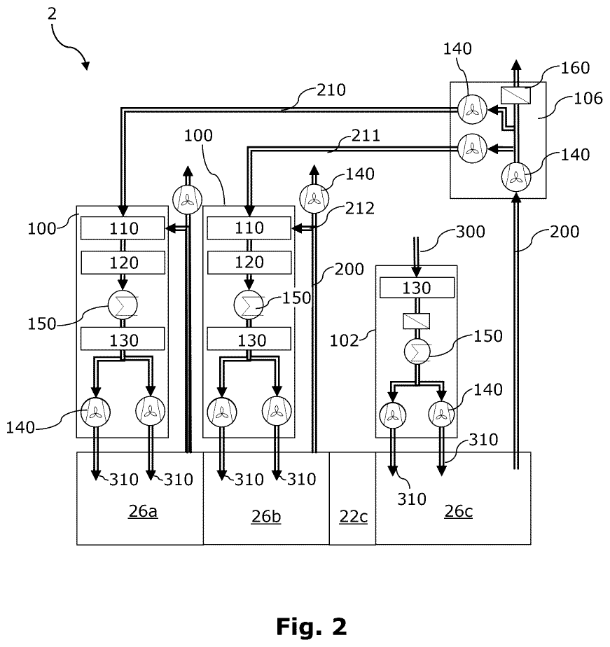

FIG. 1 shows a schematic view of a stretching unit 1 comprising an air supply system 2. Several aspects of the air supply system 2 are shown again in detail in FIG. 2.

The shown stretching unit is, for example, a film stretching unit 1 that is used for stretching plastic films 10, for example PET (polyethylene terephthalate), in the machine direction and/or transverse direction. Similarly, it is possible to stretch and/or treat other material webs using the stretching unit, such as PP (polypropylene), PE (polyethylene), PA (polyamide) or other plastics. The stretching unit is used to produce biaxially or monoaxially orientated films from an (extruded) material web.

In the production of plastic films, a melt film is initially extruded via a die (for example a slot die) onto a chill roll of a film drawing machine. Then, the cooled and at least pre-hardened melt (material web) can be removed from the film drawing machine and fed to the actual stretching unit 1. There, the stretching occurs in the machine direction and/or transverse direction in at least one stretching zone 20 as well as potential post-treatment, such as annealing, or cooling of the stretched material web (plastic film) 10 in corresponding treatment zones (annealing zones 24a-d and cooling zones 26a-26c).

The plastic film passes through the stretching unit 1 in what is termed the drawing direction A. After passing through the stretching unit 1, the stretched plastic film can be wound for example.

The individual zones can be separated by what are termed neutral zones 22a, 22b, 22c, in which no specific treatment takes place. In particular, a neutral zone 22a, 22b can be arranged between different types of zones, for example between the stretching zone 20 and the annealing zones 24a-d as well as between the annealing zones 24a-d and the cooling zones 26a, 26b. Here, a further neutral zone is located between the cooling zone 26b and the cooling zone 26c, which is the last zone of the stretching unit. Thus, no further treatment zones come after the cooling zone 26c.

In an annealing zone 24a-d, a heat treatment of the plastic film 10 can occur, in particular after ending the stretching process in the stretching zone 20. As a result, for example, a relaxation of the plastic film 10 can be achieved. As shown in FIG. 1, multiple annealing zones 24a-d can be part of the stretching unit. For example, the stretching unit can comprise at least five, or at least seven, or at least nine annealing zones. The annealing zones can be temperature-controlled differently in order to attain the desired heat treatment.

In the cooling zones 26a, 26b, 26c, the plastic film is then cooled to the extent that it can be processed further and/or packaged for further processing (for example, wound up). If multiple cooling zones 26a, 26b, 26c are provided, the temperature in the cooling zones can decrease in the drawing direction A. This enables gradual slow cooling of the plastic film 10.

The stretching unit 1 containing said at least one annealing zone 24a-d, said at least neutral zone 22a-c and/or said at least one cooling zone 26a-c can comprise one or more air-circulation apparatuses (for example in the form of a fan) and/or heating apparatuses. These can be arranged above and/or below the plastic film 10 or the material web (indicated by the fan symbol).

The stretching unit 1 is in principle a simultaneous stretching unit, in which the plastic film 10 is stretched in the actual stretching zone 20 simultaneously, thus in the machine direction and the transverse direction at the same time. Similarly, the stretching unit 1 can be a sequential stretching unit, in which the plastic film 10 is stretched, for example, first in the machine direction and then in the transverse direction (or vice versa). The stretching unit 1 can however also be in principle solely a transverse direction orienter, in which the plastic film 10 is stretched transversely to the direction of travel of the film.

An air supply system 2 is provided for the ventilation and the extraction of air in the individual zones.

In the embodiment shown here, a fresh-air supply unit 104 is assigned to the stretching zone 20. The stretching zone 20 typically comprises a preheating zone, by means of which the material web to be stretched can be preheated to a desired temperature. The fresh-air supply unit 104 comprises a fan, which draws in fresh air via a filter 130 and provides this as supply air 310 to the stretching zone 20. The filtered fresh air can also be temperature-controlled to a desired temperature by means of a heating element 150. In the example shown here, the supply air 310 is provided via a supply air distributor 312 to different positions in the stretching zone 20. For example, the supply air can be provided to the stretching zone 20 via nozzle boxes that are located below and/or above the plastic film 10.

The supply air flows over the plastic film in the stretching zone 20 and in doing so absorbs contaminants (in particular oligomers). The contaminated air can be extracted from the stretching zone as exhaust air by means of a further fan 140. In particular, the exhaust air can be removed from the stretching zone at different positions and drawn in via an exhaust-air collector 202 by means of the fan. This ventilation and extraction of air in the stretching zone 20 is characterised by a simple controllability. In one aspect, controllable dampers, in particular multileaf dampers, that are susceptible to faults can be dispensed with for controlling the air flow.

A fresh-air supply unit 104 is also assigned to the annealing zones 24a-24d, said fresh-air supply unit 104 being constructed in a similar manner to the fresh-air supply unit that is assigned to the stretching zone 20 (or the preheating zone and stretching zone). Accordingly, the fresh-air supply unit 104 of the annealing zones 24a-24d comprises a fan, which draws in fresh air via a filter 130 and provides this as supply air 310 to the annealing zones 24a-24d. The filtered fresh air can also be temperature-controlled to a desired temperature by means of a heating element 150. In the example shown here, the supply air 310 is provided via a supply air distributor 312 to different positions in the annealing zones 24a-24d or to different annealing zones 24a-24d. It is understood that multiple fresh-air supply units can also be provided to ventilate and extract air from the annealing zones 24a-24d.

The supply air flows over the plastic film in the annealing zones 24a-24d and in doing so absorbs contaminants (in particular oligomers). The contaminated air can be extracted from annealing zones 24a-24d as exhaust air by means of a further fan 140. In particular, the exhaust air can be removed from the annealing zones 24a-24d at different positions and drawn in via an exhaust-air collector 202 by means of the fan 140. This ventilation and air extraction of the annealing zones 24a-24d is characterised by a simple controllability.

The ventilation and extraction of air in the cooling zones 26a, 26b and 26c is shown in detail in FIG. 2 and described in the following. Optionally, the neutral zones can also be ventilated and air can be extracted from them. Similarly, it is possible that no controlled air exchange takes place in the neutral zones.

FIG. 2 shows a schematic view of the air supply system 2, which supplies (ventilates) the cooling zones 26a, 26b and 26c with supply air and removes (extracts) exhaust air.

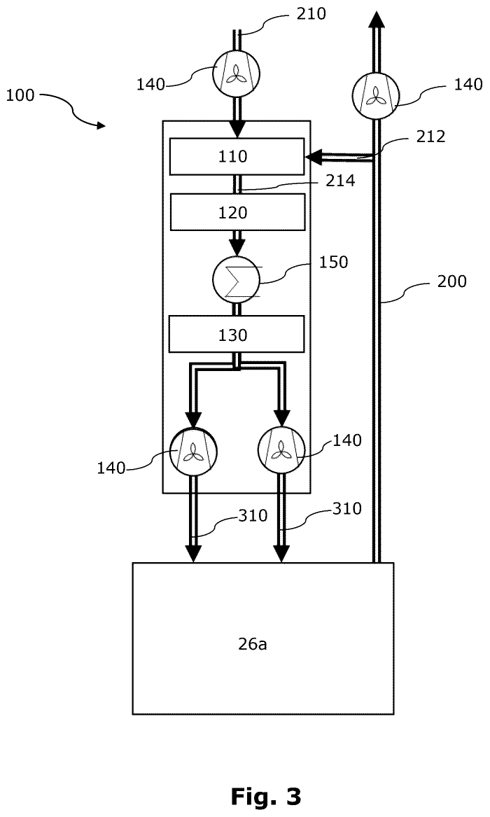

The air supply system 2 comprises at least one air supply system 100 (two in the shown exemplary embodiment). The air supply units 100 are assigned to the cooling zone 26a or the cooling zone 26b, and provide these with supply air 310. The air flow of the supply air 310 can be controlled via separate fans 140. The construction of the air supply unit 100 is shown in detail in FIG. 3 and described with reference to this.

Furthermore, the air supply system 2 comprises a fresh-air supply unit 102. This is assigned to the cooling zone 26c. The fresh-air supply unit 102 supplies fresh air 300 as supply air 310 to the cooling zone 26c. The fresh-air supply unit 102 comprises a fan, which draws in fresh air via a filter 130 and provides this as supply air 310 to the cooling zone 26c. The filtered fresh air can also be temperature-controlled to a desired temperature by means of a heating element 150. In the example shown here, the supply air 310 is provided to the cooling zone 26c via two further controllable fans 140. The supply air of the cooling zone 26c preferably solely comprises fresh air.

The supply air flows over the plastic film in the cooling zone 26c, absorbs any potentially remaining contaminants and is drawn in as exhaust air 200 by an exhaust-air return unit 106. The exhaust-air return unit 106 comprises, for example, a fan, via which the air flow of the exhaust air is controllable. The flow of exhaust air can be divided into one proportion 210 and one proportion 211 in the exhaust-air return unit 106. This can occur via corresponding controllable fans. Similarly, it is possible to provide controllable valves and/or dampers 160 that control the air flow. In addition, back-flow dampers can be provided that prevent undesirable back-flows of supply air and/or exhaust air.

The proportions 210 and 211 of exhaust air removed from the cooling zone 26c can be supplied to the air supply units 100. A further proportion can also be dissipated into the environment. The exhaust-air return unit 106 can be configured in such a way that it can set or control a ratio of the proportions 210, 211. For example, 40% of the exhaust air removed from cooling zone 26c can be supplied as proportion 210 to the air supply unit 100 which is assigned to the cooling zone 26a. In addition, 55% of the exhaust air removed from cooling zone 26c can be supplied as proportion 211 to the air supply unit 100 which is assigned to the cooling zone 26b. The remaining 5% can be dissipated into the environment. This ratio is typically not fixed but rather can be set freely.

In the air supply unit 100, a proportion 210, 211 of the exhaust air extracted from the cooling zone 26c is initially guided into a condensate trap arrangement 110 (see FIG. 3). In addition, at least a proportion 212 of the exhaust air is supplied to the condensate trap arrangement 110, said exhaust air being removed from the cooling zone 26a, 26b, to which the air supply unit 100 is assigned.

To extract exhaust air 200 and to divide the exhaust air in the proportion 212, at least one (controllable) fan 140 and/or at least one controllable valve or at least one damper can be provided.

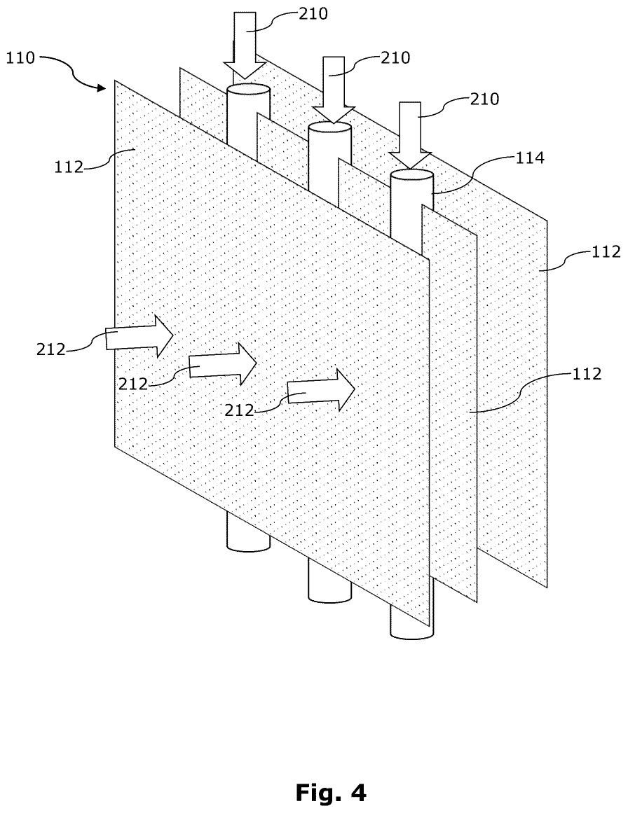

In the condensate trap arrangement 110, contaminants, in particular from the exhaust-air proportion 212, can be separated and condensed. In addition, a mixed air flow 214 comprising the proportions 210 as well as 211 and 212 is generated. The functioning of the condensate trap arrangement 110 is explained in more detail in relation to FIG. 4.

The air supply unit 100 can be designed in particular in such a way that no fresh air is supplied to the assigned treatment zone (here, cooling zone 26a and 26b), but rather solely exhaust air, which has been removed from the subsequent or last treatment or cooling zone 26c, as well as returned exhaust air from the assigned treatment zone.

After passing through the condensate trap arrangement 110, the mixed air flow can be guided through a course filter arrangement 120 and a filter arrangement 130. The condensate trap arrangement prevents the filter from clogging quickly and having to be replaced often. In addition, a heating element 150 can be provided to temperature control the mixed air flow 214. The heating element 150 can be arranged, as shown, between the course filter arrangement 120 and the filter arrangement 130. Similarly, it is possible to arrange the heating element 150 upstream of the course filter arrangement 120 or downstream of the filter arrangement 130.

The mixed and, if applicable, temperature-controlled air flow 214 can be provided to the assigned treatment zone as supply air, for example, via fans 140.

In FIG. 4, the functioning of an exemplary condensate trap arrangement 110 is shown. The condensate trap arrangement 110 comprises at least one condensation element 112. The condensation element 112 is a component part comprising a large surface on which the contaminants (in particular oligomers) precipitate or condense. Through the precipitation of the contaminants, the relative contamination in the process air sinks. The condensate trap arrangement is preferably designed in such a way that it is easily cleanable. Therefore, the air conveyed onwards is considerably cleaner.

In particular, the proportion 210, 211 of the exhaust air, which is supplied to the air supply unit 100 by the exhaust-air return unit 106, is guided in such a way through the condensate trap arrangement 110 that the condensation element 112 is temperature-controlled at a temperature that is below the condensation temperature of the contaminants. The proportion 210, 211 of the exhaust air that is supplied to the air supply unit 100 by the exhaust-air return unit 106 can have here a first temperature T1 or be accordingly temperature-controlled. In the shown example, the proportion 210 is guided through ducts that are coupled to the condensation element 112 in such a way that heat can be transferred.

The proportion 212 of the exhaust air that has been extracted from the assigned treatment zone (here, cooling zone 26a and 26b) is guided to the temperature-controlled condensation element 112. In doing so, there is condensation of the contaminants.

The embodiment of the condensate trap arrangement 110 shown here is only exemplary and other condensate trap arrangements 110 can also be used.

To clean the condensate trap arrangement 110 and to remove the condensate, the condensation element 112 or condensation elements 112 can be removed and replaced, or can be cleaned.

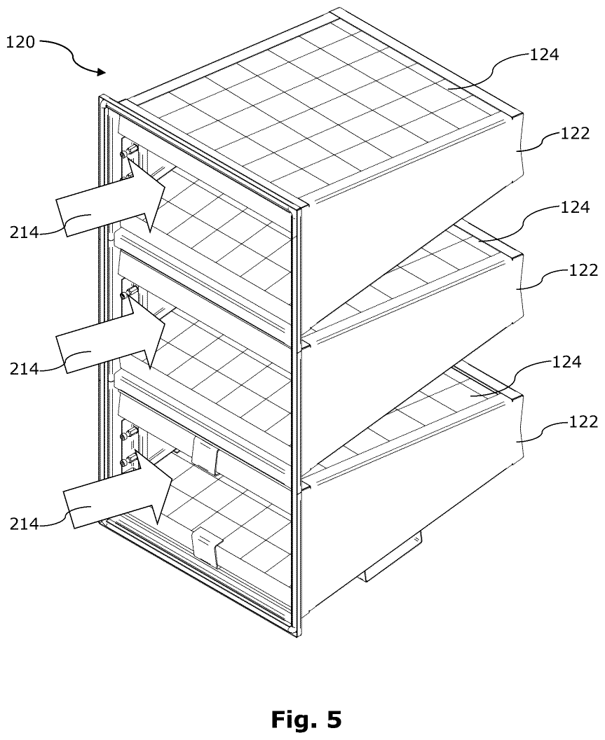

FIG. 5 shows a schematic view of a course filter arrangement 120. The mixed air flow 214 flows through the coarse filter arrangement 120. The course filter arrangement 120 comprises a plurality of course filters 124 (for example, a metal knit, a stretch plate, an expanded-metal grid, a wire mesh, a perforated plate, a honeycomb plate, a non-woven filter and/or suchlike) which have been inserted in a corresponding filter frame 122. The course filters 124 can be reusable or can be replaced after use.

1. An air supply system for a stretching unit, comprising:
at least one air supply unit;
at least one fresh-air supply unit, and
at least one exhaust-air return unit, wherein
the exhaust-air return unit and the fresh-air supply unit are assigned to a mutual first treatment zone, wherein
the fresh-air supply unit is configured to supply fresh air as supply air to the first treatment zone, and wherein the
exhaust-air return unit is configured to extract exhaust air from the first treatment zone and to supply at least a proportion of the exhaust air to at least one air supply unit, wherein
the air supply unit is assigned to a second treatment zone, said second treatment zone being upstream of the first treatment zone, and wherein the air supply unit is configured to
provide the proportion of the exhaust air supplied to it by the exhaust-air return unit to the second treatment zone as supply air.

2. The air supply system according to claim 1, wherein the air supply system is configured furthermore to extract exhaust air from a second treatment zone, and wherein
the air supply unit is configured furthermore to mix at least a proportion of the exhaust air extracted from the second treatment zone with at least a proportion of the exhaust air supplied to the air supply unit by the exhaust-air return unit in order to generate a mixed air flow, and to provide the mixed air flow to the second treatment zone as supply air.

3. The air supply system according to claim 1, wherein the air supply system is configured to supply solely fresh air as supply air to the first treatment zone.

4. The air supply system according to claim 1, wherein the air supply unit is configured to supply
solely the proportion of exhaust air supplied to it by the exhaust-air return unit or
a mixed air flow comprising no fresh air
to the second treatment zone as supply air.

5. The air supply system according to claim 1, wherein the exhaust-air return unit is configured to extract the entire exhaust air from the first treatment zone.

6. The air supply system according to claim 1, wherein the air supply system comprises at least one controllable fan, wherein said at least one controllable fan is configured
to control a supply-air air flow of the first treatment zone, or
to control a supply-air air flow of the second treatment zone, or
to control an exhaust-air air flow of the first treatment zone, or
to control an exhaust-air air flow of the second treatment zone, or
to control an air flow that is supplied to said at least one air supply unit by the exhaust-air return unit.

7. The air supply system according to claim 1, wherein the air supply system comprises at least one heating element, wherein said at least one heating element is configured
to temperature control a supply-air air flow of the first treatment zone, or
to temperature control a supply-air air flow of the second treatment zone.

8. The air supply system according to claim 1, wherein the air supply system comprises a condensate trap arrangement with at least one condensation element, wherein the condensate trap arrangement is configured
to have a proportion of the exhaust air flow through it, said proportion of the exhaust air being supplied to the air supply unit by the exhaust-air return unit and having a first temperature (T1) to temperature control the condensation element; wherein the condensate trap arrangement is configured furthermore
to have a proportion of the exhaust air extracted from the second treatment zone flow through it, which has a second temperature (T2), wherein the second temperature (T2) is greater than the first temperature (T1), and wherein said at least one temperature-controlled condensation element is configured in such a way that
contaminants, which are entrained in the exhaust air extracted from the second treatment zone, at least in part condense on said at least one condensation element.

9. The air supply system according to claim 8, wherein the condensate trap arrangement is configured furthermore to mix exhaust-air proportions flowing through it in order to generate a mixed air flow.

10. The air supply system according to claim 8, wherein the condensation element comprises a perforated plate or a honeycomb structure.

11. The air supply system according to claim 1, wherein the air supply unit further comprises a course filter arrangement that is optionally downstream of the condensate trap arrangement.

12. The air supply system according to claim 1, wherein the air supply unit further comprises a filter arrangement that is optionally downstream of the course filter arrangement.

13. The air supply system according to claim 1, wherein the air supply system comprises a plurality of air supply units, wherein the exhaust-air return unit is configured to extract exhaust air from the first treatment zone and at least supply a proportion of the exhaust air to the air supply units, wherein
the air supply units are each assigned to a treatment zone upstream of the first treatment zone in order to supply this with supply air.

14. A stretching unit for stretching a plastic film in the machine direction and/or transverse direction, wherein the stretching unit comprises
a stretching zone;
at least two treatment zones, which are arranged downstream of the stretching zone, and
the air supply system according to claim 1.

15. The stretching unit according to claim 14, wherein said at least two treatment zones comprise at least one cooling zone and/or at least one annealing zone, and wherein the first treatment zone is a treatment zone that is not succeeded by any further treatment zone.
